(19) United States
(12) Patent Application Publication
(10) Pub. No.: US 2025/0210903 A1
(43) Pub. Date: Jun. 26, 2025

(54) CONNECTOR

(71) Applicant: SUMITOMO WIRING SYSTEMS, LTD., Mie (JP)

(72) Inventors: Hiroto TANAKA, Mie (JP); Hiroki KATO, Mie (JP)

(21) Appl. No.: 18/981,976

(22) Filed: Dec. 16, 2024

(30) Foreign Application Priority Data
Dec. 22, 2023 (JP) 2023-216524

(51) Int. Cl. H01R 13/436; H01R 13/506

(52) U.S. Cl. CPC H01R 13/4365; H01R 13/506

(57) ABSTRACT

A connector includes a retainer attached in an attachment direction intersecting an insertion direction of a terminal. The housing has a first protrusion and a second protrusion, an upper wall of the retainer has a first locking portion positioned in an attachment rearward direction relative to the first protrusion at the temporary locking position and positioned between the first protrusion and the second protrusion at the full locking position, and a separation preventing portion positioned in an attachment forward direction relative to the second protrusion at the temporary locking position and at the full locking position. The first locking portion is capable of moving over the first protrusion, the second protrusion has a key recess that is recessed in the attachment rearward direction, and the separation preventing portion has a key protrusion that fits into the key recess at the temporary locking position.

### CROSS-REFERENCE TO RELATED APPLICATIONS

This application is based on and claims priority from Japanese Patent Application No. 2023-216524, filed on Dec. 22, 2023, with the Japan Patent Office, the disclosure of which is incorporated herein in its entirety by reference.

### TECHNICAL FIELD

The present disclosure relates to a connector.

### BACKGROUND

Conventionally, a connector includes a terminal, a housing into which the terminal is inserted, and a retainer attached to the housing in an attachment direction intersecting a direction in which the terminal is inserted (the insertion direction of the terminal) (e.g., see JP 2013-016519A). The retainer has an upper wall and a retaining wall that are parallel to each other and between which the housing is disposed, and a side wall linking the upper wall and the retaining wall together at their end portions in an attachment rearward direction. Also, as a result of the retaining wall having a locking portion being bent, the retainer is movable between a temporary locking position at which movement of the terminal in and out of the housing is allowed and a full locking position that is located in the attachment forward direction relative to the temporary locking position and at which movement of the terminal out of the housing is restricted. Also, the housing has a separation restricting surface that is substantially perpendicular to the attachment direction, the retainer has a rear locking surface that is substantially perpendicular to the attachment direction, and engagement between the separation restricting surface and the rear locking surface at the temporary locking position prevents the retainer from separating from the housing.

### SUMMARY

However, in the above-described connector, for example, even when a slight twisting force is applied, a component force, which may bend the retaining wall, may be generated by the separation restricting surface and the rear locking surface, resulting in the retainer separating from the housing.

The present disclosure aims to provide a connector capable of preventing a retainer from separating from a housing.

A connector according to the present disclosure includes: a terminal; a housing into which the terminal is inserted; and a retainer attached to the housing in an attachment direction intersecting an insertion direction of the terminal, in which the retainer has an upper wall and a lower wall that are parallel to each other and between which the housing is disposed, and a base end linking wall that links the upper wall and the lower wall together at an end portion in an attachment rearward direction, and is movable between a temporary locking position at which movement of the terminal in and out of the housing is allowed and a full locking position that is located in an attachment forward direction relative to the temporary locking position and at which movement of the terminal out of the housing is restricted, the housing has a first protrusion and a second protrusion positioned in the attachment forward direction relative to the first protrusion, the upper wall has a first locking portion positioned in the attachment rearward direction relative to the first protrusion at the temporary locking position and positioned between the first protrusion and the second protrusion at the full locking position, and a separation preventing portion positioned in the attachment forward direction relative to the second protrusion at the temporary locking position and at the full locking position, the first locking portion is capable of moving over the first protrusion due to the upper wall bending upward when the retainer moves between the temporary locking position and the full locking position, the second protrusion has a key recess that is recessed in the attachment rearward direction, and the separation preventing portion has a key protrusion that fits into the key recess at the temporary locking position to prevent the upper wall from bending upward.

According to the connector of the present disclosure, it is possible to prevent the retainer from separating from the housing.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a connector according to an embodiment.

FIG. 2 is an exploded perspective view of the connector according to the embodiment.

FIG. 3 is a perspective view of the connector according to the embodiment at a temporary locking position.

FIG. 4 is a perspective view of a retainer according to an embodiment.

FIG. 5 is a perspective view of the retainer according to the embodiment.

FIG. 6 is a rear view of the retainer according to the embodiment.

FIG. 7 is a cross-sectional view taken along line 7-7 in FIG. 6.

FIG. 8 is a cross-sectional view taken along line 8-8 in FIG. 1.

FIG. 9 is a cross-sectional view taken along line 9-9 in FIG. 1.

FIG. 10 is a cross-sectional view taken along line 10-10 in FIG. 3.

FIG. 11 is a cross-sectional view taken along line 11-11 in FIG. 3.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of the Present Disclosure

First, embodiments of the present disclosure will be listed and described below.

[1] A connector according to the present disclosure is a connector including: a terminal; a housing into which the terminal is inserted; and a retainer attached to the housing in an attachment direction intersecting an insertion direction of the terminal, in which the retainer has an upper wall and a lower wall that are parallel to each other and between which the housing is disposed, and a base end linking wall that links the upper wall and the lower wall together at an end portion in an attachment rearward direction, and is movable between a temporary locking position at which movement of the terminal in and out of the housing is allowed and a full locking position that is located in an attachment forward direction relative to the temporary locking position and at which movement of the terminal out of the housing is restricted, the housing has a first protrusion and a second protrusion positioned in the attachment forward direction relative to the first protrusion, the upper wall has a first locking portion positioned in the attachment rearward direction relative to the first protrusion at the temporary locking position and positioned between the first protrusion and the second protrusion at the full locking position, and a separation preventing portion positioned in the attachment forward direction relative to the second protrusion at the temporary locking position and at the full locking position, the first locking portion is capable of moving over the first protrusion due to the upper wall bending upward when the retainer moves between the temporary locking position and the full locking position, the second protrusion has a key recess that is recessed in the attachment rearward direction, and the separation preventing portion has a key protrusion that fits into the key recess at the temporary locking position to prevent the upper wall from bending upward.

With this configuration, the first locking portion of the upper wall is configured to move over the first protrusion of the housing due to the upper wall bending upward when the retainer moves between the temporary locking position and the full locking position, thereby preventing the retainer from being easily switched to the temporary locking position or the full locking position. The retainer can be switched to the temporary locking position or the full locking position by applying a certain degree of operating force thereto. Since the second protrusion of the housing has a key recess that is recessed in the attachment rearward direction of the retainer, the separation preventing portion of the retainer has the key protrusion that fits into the key recess at the temporary locking position to prevent the upper wall from bending upward, and separation of the retainer from the housing is prevented. That is, even when a large force in the attachment rearward direction is applied to the retainer at the temporary locking position, the key protrusion is fitted into the key recess, preventing the upper wall from bending upward and preventing the separation preventing portion from moving over the second protrusion. This prevents the retainer from separating from the housing.

[2] In [1] above, the separation preventing portion may be provided at an end portion of the upper wall in the attachment forward direction.

With this configuration, since the separation preventing portion is provided at the end portion of the upper wall in the attachment forward direction, the upper wall can be prevented from bending upward at a portion where the upper wall is most likely to be displaced in the attachment direction when the upper wall bends upward. Therefore, it is possible to effectively prevent the upper wall from bending upward.

[3] In [1] above or [2] above, the retainer may have a linking portion that links the upper wall and the lower wall together at an end portion in an insertion forward direction of the terminal, and the first locking portion and the separation preventing portion may be provided at an end portion of the upper wall that is opposite to the linking portion.

With this configuration, the retainer has the linking portion that links the upper wall and the lower wall together at the end portion in the insertion forward direction of the terminal, thus ensuring high rigidity of the entire retainer and making the upper wall and the lower wall less likely to bend in the insertion forward direction of the terminal. Also, the first locking portion and the separation preventing portion are provided in a flexible portion of an end portion of the upper wall that is opposite to the linking portion, and thus can function normally. That is, for example, when the first locking portion and the separation preventing portion are provided closer to the linking portion relative to the end portion of the upper wall that is opposite to the linking portion, the upper wall will be less likely to bend and thus there is a risk that the first locking portion and the separation preventing portion may not function normally, but this risk can be avoided.

[4] In any one of [1] above to [3] above, the housing may have a third protrusion positioned in the attachment rearward direction relative to the first protrusion, the upper wall may have a second locking portion that is positioned in the attachment rearward direction relative to the third protrusion at the temporary locking position and positioned between the first protrusion and the third protrusion at the full locking position, and the second locking portion may be capable of moving over the third protrusion due to the upper wall bending upward when the retainer moves between the temporary locking position and the full locking position.

With this configuration, the second locking portion of the upper wall is configured to move over the third protrusion of the housing due to the upper wall bending upward when the retainer moves between the temporary locking position and the full locking position, thereby preventing the retainer from being easily switched to the temporary locking position or the full locking position. That is, the second locking portion functions in a manner similar to that of the first locking portion. This further prevents the retainer from being easily switched to the temporary locking position or the full locking position. In other words, the state in which the retainer is located at the temporary locking position or the full locking position can be more strongly maintained.

[5] In [4] above, the housing may have a fourth protrusion positioned in the attachment rearward direction relative to the third protrusion, in the state in which the retainer is located at the temporary locking position, the second locking portion may be positioned between the third protrusion and the fourth protrusion, and in the state in which the retainer is located at the temporary locking position, a surface of the fourth protrusion facing the second locking portion may be a first orthogonal surface orthogonal to the attachment direction, and in the state in which the retainer is located at the temporary locking position, a surface of the second locking portion facing the fourth protrusion may be a second orthogonal surface orthogonal to the attachment direction.

With this configuration, in the state in which the retainer is located at the temporary locking position, the surface of the fourth protrusion facing the second locking portion is the first orthogonal surface orthogonal to the attachment direction, and the surface of the second locking portion facing the fourth protrusion is the second orthogonal surface orthogonal to the attachment direction. Thus, a component force for bending the upper wall upward is unlikely to be generated. This inhibits a large force from being applied to the key protrusion and the key recess. The engagement between the fourth protrusion and the second locking portion also prevents the retainer from separating from the housing.

### Details of Embodiments of the Present Disclosure

Specific examples of the present disclosure will be described below with reference to the drawings. In each drawing, for convenience of description, portions of the configuration may be exaggerated or simplified. Also, the dimensional proportions of each portion may differ between drawings. Note that the present invention is not limited to these examples, and is indicated by the claims, and is intended to include all modifications within the meaning and scope equivalent to the claims.

### Configuration of Connector 11

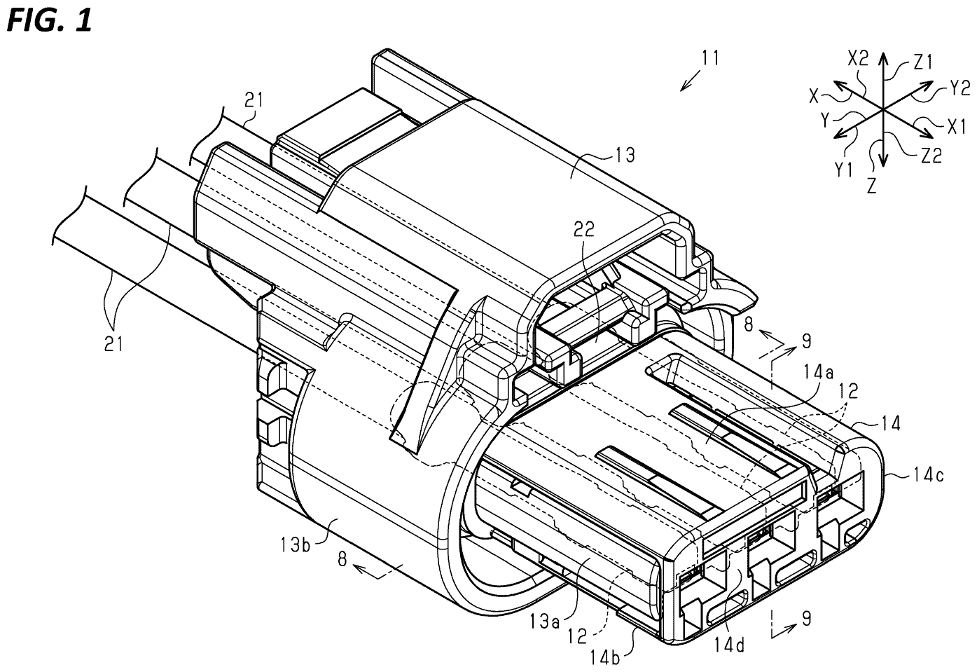

As shown in FIGS. 1 to 3, a connector 11 includes terminals 12, a housing 13, and a retainer 14. Note that a first axis X, a second axis Y orthogonal to the first axis X, and a third axis Z orthogonal to the first axis X and the second axis Y are shown in the drawings. Also, an insertion direction X1, which is one direction along the first axis X, in other words, an insertion forward direction X1, and an insertion rearward direction X2, which is another direction along the first axis X and is opposite to the insertion forward direction X1 are shown in the drawings. Also, an attachment direction Y1, which is one direction along the second axis Y, in other words, an attachment forward direction Y1, and an attachment rearward direction Y2, which is another direction along the second axis Y and is opposite to the attachment forward direction Y1 are shown in the drawings. Also, an upward direction Z1, which is one direction along the third axis Z, and a downward direction Z2, which is another direction along the third axis Z and is opposite to the upward direction Z1 are shown in the drawings.

### Configuration of Terminal 12

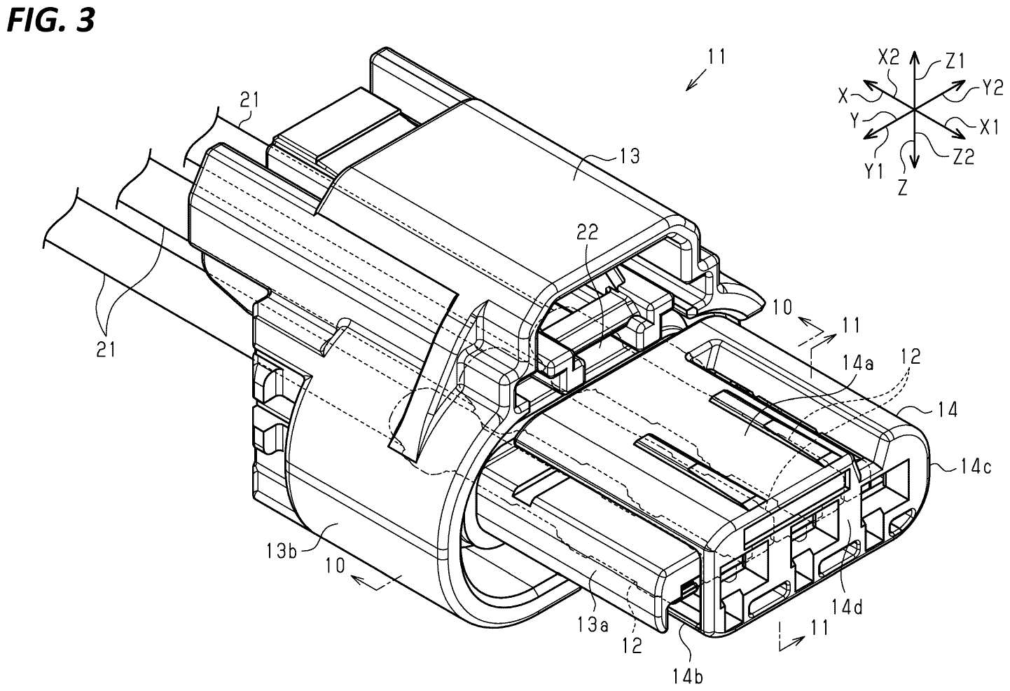

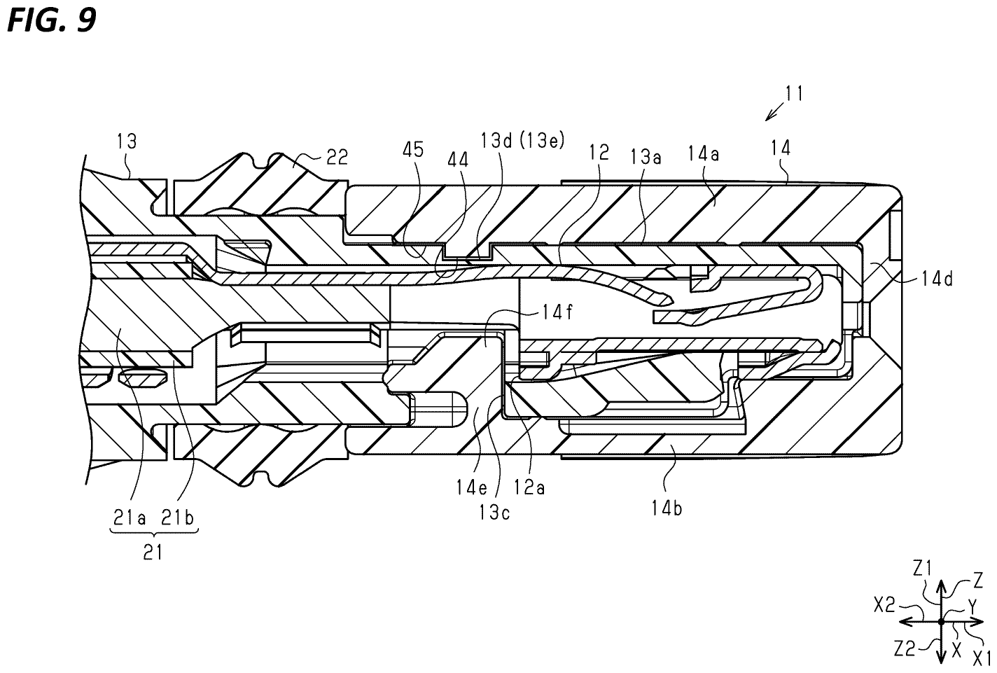

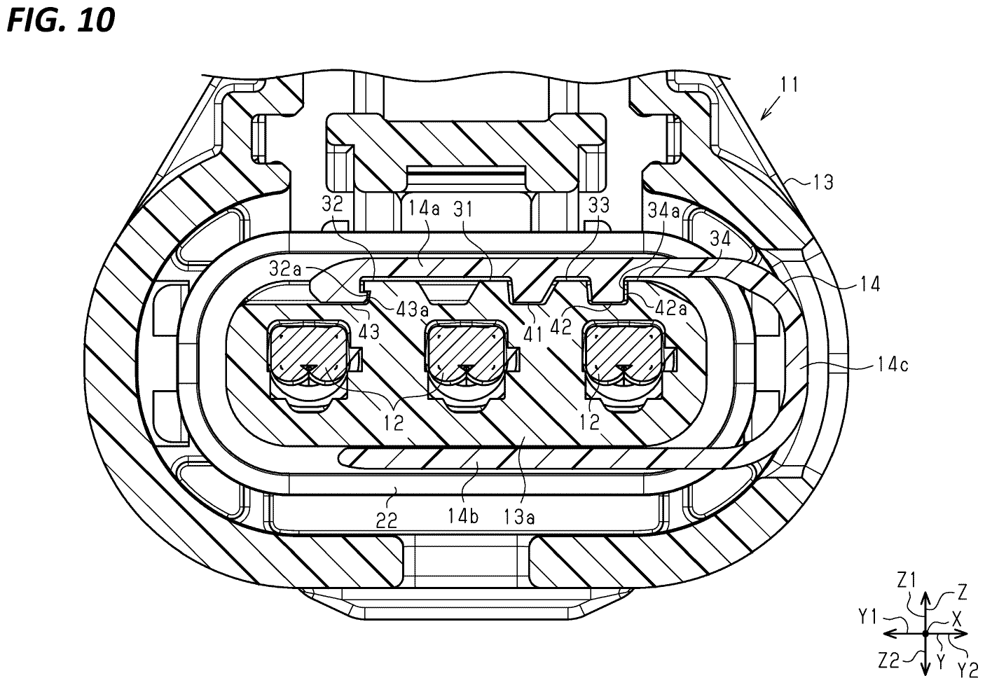

As shown in FIGS. 3 and 9, each terminal 12 is a female terminal that extends along the first axis X and is made of metal. A base end portion of the terminal 12 is connected to a wire 21. Specifically, as shown in FIG. 9, the wire 21 has a core wire 21a formed by a conductor, and an insulating sheath 21b that covers an outer circumference of the core wire 21a. A base end portion of the terminal 12 is connected to an end portion of the core wire 21a that is exposed from the end portion of the wire 21. As shown in FIGS. 1 to 3, the connector 11 of this embodiment includes a plurality of terminals 12, that is, three terminals 12. The three terminals 12 are arranged side-by-side along the second axis Y.

### Configuration of Housing 13

The housing 13 is made of resin.

As shown in FIGS. 1 to 3, the housing 13 includes a tubular portion 13a that extends along the insertion direction X1 of the terminals 12 such that the terminals 12 can be inserted therein, and an outer portion 13b that is linked to the base end portion of the tubular portion 13a and covers the base end side of the tubular portion 13a. The tubular portion 13a is formed to be capable of holding three terminals 12 arranged side-by-side along the second axis Y.

As shown in FIG. 9, the tubular portion 13a has a continuous hole 13c that is continuous from the downward direction Z2 to a portion where the terminals 12 are disposed and extends along the second axis Y. The continuous hole 13c is continuous within a range along the second axis Y including all of the three terminals 12 arranged side-by-side along the second axis Y.

Also, a waterproof rubber ring 22 is fitted to the outer circumference of the tubular portion 13a on the base end side. While a counterpart connector (not shown) is fitted to the connector 11, the waterproof rubber ring 22 is compressed by the counterpart connector to prevent the entry of liquid.

### Configuration of Retainer 14

The retainer 14 is made of resin.

As shown in FIGS. 1 to 3, the retainer 14 is attached to the tubular portion 13a of the housing 13 in the attachment direction Y1 intersecting the insertion direction X1 of the terminals 12.

The retainer 14 has the upper wall 14a and the lower wall 14b that are parallel to each other and between which the tubular portion 13a of the housing 13 is disposed, and a base end linking wall 14c that links the upper wall 14a and the lower wall 14b together at an end portion in the attachment rearward direction Y2 of the retainer 14. Also, the retainer 14 has a linking portion 14d that links the upper wall 14a and the lower wall 14b together at an end portion in the insertion forward direction X1 of the terminals 12. The linking portion 14d links the upper wall 14a and the lower wall 14b together, except for the portions corresponding to the three terminals 12.

Also, the retainer 14 is movable between the temporary locking position (see FIG. 3) at which movement of the terminals 12 in and out of the housing 13 is allowed and the full locking position (see FIG. 1) that is located in the attachment forward direction Y1 relative to the temporary locking position and at which movement of the terminals 12 out of the housing 13 is restricted.

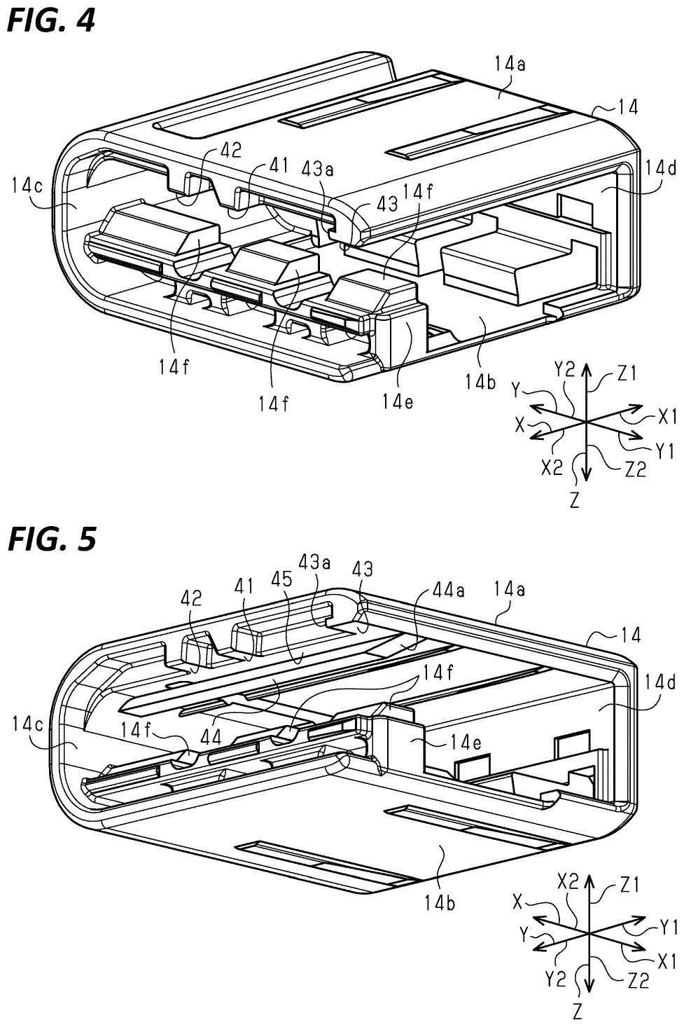

Specifically, as shown in FIG. 9, the lower wall 14b of the retainer 14 has a base portion 14e that extends along the attachment direction Y1 of the retainer 14 and fits into the continuous hole 13c of the housing 13. As shown in FIG. 4, the base portion 14e is formed on the entire lower wall 14b in the attachment direction Y1. The base portion 14e has movement restricting protrusions 14f that can be engaged with the terminals 12 to restrict the movement of the terminals 12 out of the housing at the full locking position.

The movement restricting protrusions 14f are provided at parts of the base portion 14e in the attachment direction Y1. Three movement restricting protrusions 14f of this embodiment are arranged side-by-side in the attachment direction Y1, to correspond to the three terminals 12. As shown in FIG. 9, the movement restricting protrusions 14f are disposed at positions where they can be engaged with engaged portions 12a of the terminals 12 at the full locking position, thereby restricting the movement of the terminals 12 out of the housing 13, in other words, restricting the movement of the terminals 12 in the insertion rearward direction X2. Also, as shown in FIG. 11, the movement restricting protrusions 14f are disposed at positions where they cannot be engaged with the engaged portions 12a of the terminals 12 at the temporary locking position, thereby allowing the movement of the terminals 12 in and out of the housing 13.

### Detailed Configuration of Housing 13 and Retainer 14

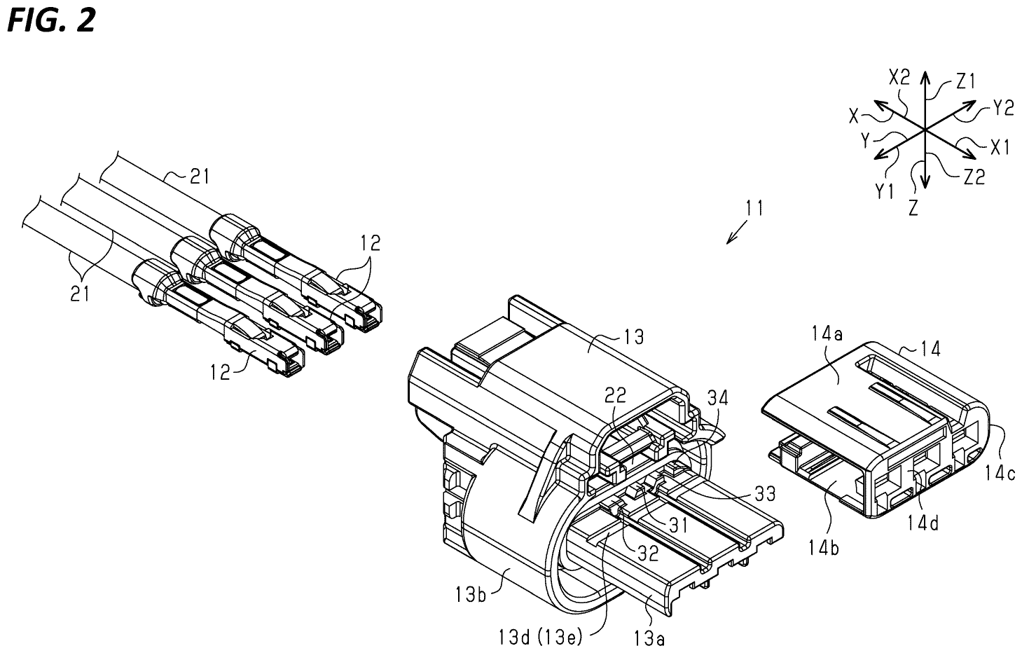

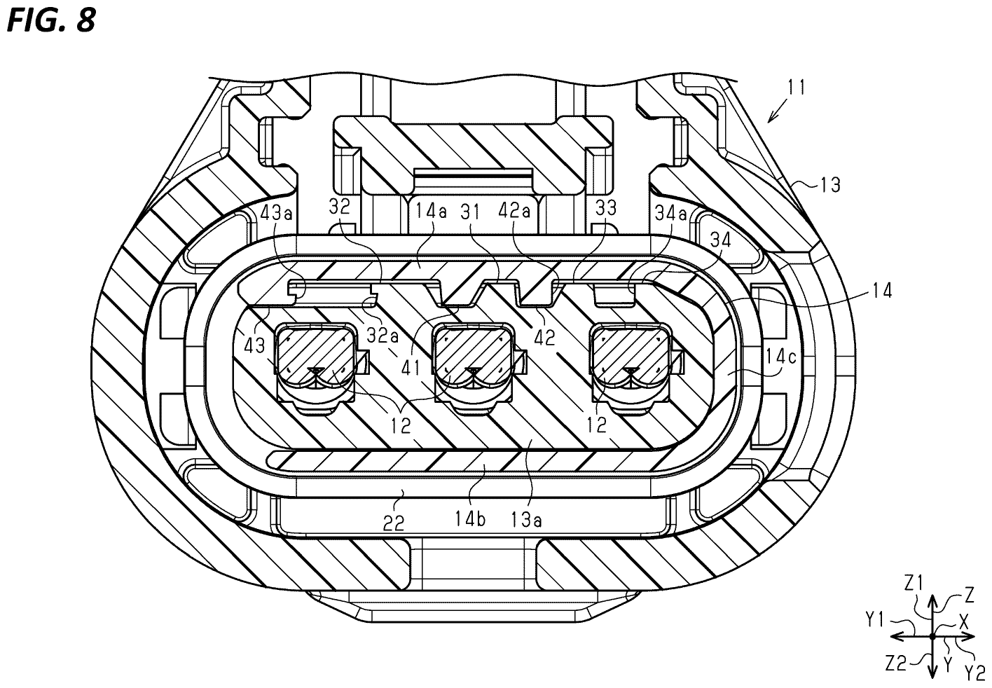

As shown in FIGS. 2 and 8, the housing 13 has a first protrusion 31, a second protrusion 32, a third protrusion 33, and a fourth protrusion 34 on a surface of the tubular portion 13a facing the upper wall 14a of the retainer 14. The first protrusion 31, the second protrusion 32, the third protrusion 33, and the fourth protrusion 34 protrude in the upward direction Z1 from the tubular portion 13a. The second protrusion 32 is disposed in the attachment forward direction Y1 relative to the first protrusion 31. The third protrusion 33 is disposed in the attachment rearward direction Y2 relative to the first protrusion 31. The fourth protrusion 34 is disposed in the attachment rearward direction Y2 relative to the third protrusion 33.

As shown in FIGS. 4 to 6 and 8, the upper wall 14a of the retainer 14 has a first locking portion 41, a second locking portion 42, and a separation preventing portion 43. The first locking portion 41, the second locking portion 42, and the separation preventing portion 43 protrude in the downward direction Z2 from the upper wall 14a. Also, the first locking portion 41, the second locking portion 42, and the separation preventing portion 43 are provided at an end portion of the upper wall 14a that is opposite to the linking portion 14d, in other words, an end portion in the insertion rearward direction X2. The second locking portion 42 is disposed in the attachment rearward direction Y2 relative to the first locking portion 41. The separation preventing portion 43 is disposed in the attachment forward direction Y1 relative to the first locking portion 41. Also, the separation preventing portion 43 is provided at the end portion of the upper wall 14a in the attachment forward direction Y1.

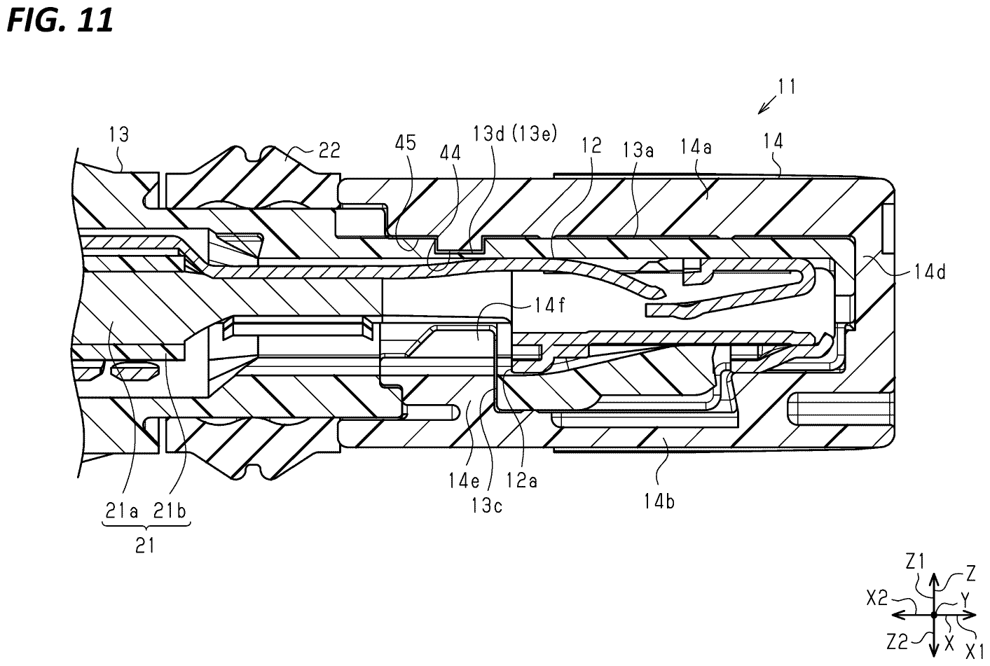

As shown in FIG. 10, the first locking portion 41 is disposed between the first protrusion 31 and the third protrusion 33, in the attachment rearward direction Y2 relative to the first protrusion 31 at the temporary locking position. As shown in FIG. 8, the first locking portion 41 is disposed between the first protrusion 31 and the second protrusion 32, in the attachment forward direction Y1 relative to the first protrusion 31 at the full locking position.

The first locking portion 41 disposed as described above is capable of moving over the first protrusion 31 due to the upper wall 14a bending in the upward direction Z1 when the retainer 14 moves between the temporary locking position and the full locking position.

As shown in FIG. 10, the second locking portion 42 is disposed between the third protrusion 33 and the fourth protrusion 34 in the attachment rearward direction Y2 relative to the third protrusion 33 at the temporary locking position. As shown in FIG. 8, the second locking portion 42 is disposed between the first protrusion 31 and the third protrusion 33 in the attachment forward direction Y1 relative to the third protrusion 33 at the full locking position.

The second locking portion 42 disposed as described above is capable of moving over the third protrusion 33 due to the upper wall 14a bending in the upward direction Z1 when the retainer 14 moves between the temporary locking position and the full locking position.

Note that in this embodiment, in the state in which the retainer 14 is located at the temporary locking position (see FIG. 10) or the full locking position (see FIG. 8), the opposing surfaces of the first protrusion 31 and the first locking portion 41 are inclined surfaces, which are inclined with respect to a plane orthogonal to the attachment direction Y1. Also, in the state in which the retainer 14 is located at the temporary locking position or the full locking position, the opposing surfaces of the third protrusion 33 and the second locking portion 42 are inclined surfaces, which are inclined with respect to a plane orthogonal to the attachment direction Y1. These inclined surfaces are set such that, when a force is applied to the retainer 14 in the attachment forward direction Y1 or the attachment rearward direction Y2, a component force is generated to bend the upper wall 14a in the upward direction Z1. Thus, by applying a force to the retainer 14 in the attachment forward direction Y1 or the attachment rearward direction Y2, the upper wall 14a can be bent in the upward direction Z1. Therefore, the first locking portion 41 moves over the first protrusion 31 and the second locking portion 42 moves over the third protrusion 33, and thus the retainer 14 can be moved to the temporary locking position or the full locking position. Note that each inclined surface is set to have a large or small inclination angle depending on the force required to operate the retainer 14.

As shown in FIG. 10, in the state in which the retainer 14 is located at the temporary locking position, a surface of the fourth protrusion 34 facing the second locking portion 42 is a first orthogonal surface 34a that is orthogonal to the attachment direction Y1. Also, in the state in which the retainer 14 is located at the temporary locking position, a surface of the second locking portion 42 facing the fourth protrusion 34 is a second orthogonal surface 42a that is orthogonal to the attachment direction Y1. As a result, a configuration is adopted in which, even when a force is applied to the retainer 14 in the attachment rearward direction Y2 in the state in which the retainer 14 is located at the temporary locking position, a component force that bends the upper wall 14a in the upward direction Z1 is unlikely to be generated.

The second protrusion 32 has a key recess 32a that is recessed in the attachment rearward direction Y2, the separation preventing portion 43 has a key protrusion 43a that fits into the key recess 32a at the temporary locking position to prevent the upper wall 14a from bending in the upward direction Z1. The key recess 32a is formed at a base end portion of the second protrusion 32 protruding in the upward direction Z1 from the tubular portion 13a. The key protrusion 43a is formed at a leading end portion of the separation preventing portion 43 protruding in the downward direction Z2 from the upper wall 14a. In this embodiment, the thickness along the third axis Z of a portion of the second protrusion 32 that protrudes in the attachment forward direction Y1 due to the formation of the key recess 32a is set to be the same as the thickness of the key protrusion 43a along the third axis Z.

Also, as shown in FIGS. 2 and 9, the tubular portion 13a of the housing 13 has a guide groove 13d extending along the attachment direction Y1. The guide groove 13d of this embodiment has a bottom portion 13e. In other words, the guide groove 13d is not continuous to a portion where the terminal 12 is disposed. Also, as shown in FIG. 9, the upper wall 14a of the retainer 14 has a guide rib 44 that extends along the attachment direction Y1 and fits into the guide groove 13d.

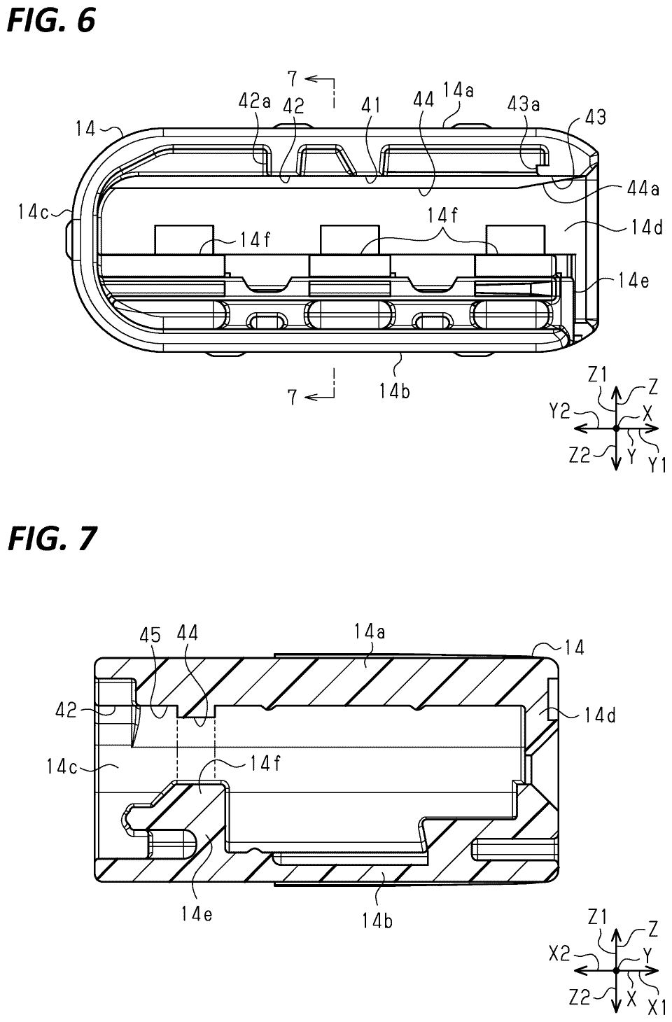

As shown in FIGS. 5 and 6, the guide rib 44 has an inclined portion 44a at its end portion in the attachment forward direction Y1, the inclined portion 44a protruding from the upper wall 14a with the amount of the protrusion decreasing toward the end portion. Also, the guide rib 44 is continuous over the entire upper wall 14a in the attachment direction Y1 of the retainer 14. Also, as shown in FIG. 5, the guide rib 44 is provided spaced apart from the first locking portion 41, the second locking portion 42, and the separation preventing portion 43 in the insertion direction X1. In other words, the guide rib 44 is provided with respect to the first locking portion 41, the second locking portion 42, and the separation preventing portion 43, via a flat surface 45.

Also, as shown in FIG. 7, the guide rib 44 is provided at a position where the guide rib 44 overlaps with the base portion 14e in the insertion direction X1. In this embodiment, the guide rib 44 is provided such that the entire guide rib 44 is accommodated in a range where the base portion 14e is provided, in the insertion direction X1. Also, as shown in FIG. 9, the guide groove 13d is provided at a position where the guide groove 13d overlaps with the continuous hole 13c in the insertion direction X1.

### Functional Effects of Embodiment

Next, functional effects of this embodiment will be described.

The retainer 14 is attached to the tubular portion 13a of the housing 13 in the attachment direction Y1 intersecting the insertion direction X1 of the terminals 12. Specifically, the retainer 14 is attached to the housing 13 such that the tubular portion 13a of the housing 13 is inserted between the leading end portions of the upper wall 14a and the lower wall 14b.

Also, the movement restricting protrusions 14f are disposed at positions where they cannot be engaged with the engaged portions 12a of the terminals 12 in the state in which the retainer 14 is located at the temporary locking position (see FIGS. 10 and 11), thereby allowing movement of the terminals 12 in and out of the housing 13.

Also, the movement restricting protrusions 14f are disposed at positions where they can be engaged with the engaged portions 12a of the terminals 12 in the state in which the retainer 14 is located at the full locking position (see FIGS. 8 and 9), thereby restricting the movement of the terminals 12 out of the housing 13.

### Effects of Embodiment

Next, effects of the above embodiment will be described below.

(1) The first locking portion 41 of the upper wall 14a is configured to move over the first protrusion 31 of the housing 13 due to the upper wall 14a bending in the upward direction Z1 when the retainer 14 moves between the temporary locking position and the full locking position. Thus, the retainer 14 is prevented from being easily, for example unintentionally, switched to the temporary locking position or the full locking position. The retainer 14 can be switched to the temporary locking position or the full locking position by applying a certain degree of operating force thereto. Also, the second protrusion 32 of the housing 13 has a key recess 32a that is recessed in the attachment rearward direction Y2 of the retainer 14, and the separation preventing portion 43 of the retainer 14 has the key protrusion 43a that fits into the key recess 32a at the temporary locking position to prevent the upper wall 14a from bending in the upward direction Z1. This prevents the retainer 14 from separating from the housing 13. That is, even when a large force is applied to the retainer 14 in the attachment rearward direction Y2 at the temporary locking position, the key protrusion 43a is fitted into the key recess 32a, preventing the upper wall 14a from bending in the upward direction Z1 and preventing the separation preventing portion 43 from moving over the second protrusion 32. This prevents the retainer 14 from separating from the housing 13.

(2) Since the separation preventing portion 43 is provided at the end portion of the upper wall 14a in the attachment forward direction Y1, the upper wall 14a can be prevented from bending in the upward direction Z1 at a portion where the upper wall 14a is most likely to be displaced in the attachment direction Y1 when the upper wall 14a bends in the upward direction Z1. Therefore, it is possible to effectively prevent the upper wall 14a from bending in the upward direction Z1.

(3) The retainer 14 has the linking portion 14d that links the upper wall 14a and the lower wall 14b together at the end portion in the insertion forward direction X1 of the terminals 12, thus ensuring high rigidity of the entire retainer 14 and making the upper wall 14a and the lower wall 14b less likely to bend in the insertion forward direction X1 of the terminals 12. Also, the first locking portion 41, the second locking portion 42, and the separation preventing portion 43 are provided in a flexible portion of an end portion of the upper wall 14a that is opposite to the linking portion 14d, and thus can function normally. That is, for example, when the first locking portion 41, the second locking portion 42, and the separation preventing portion 43 are provided closer to the linking portion 14d relative to the end portion of the upper wall 14a that is opposite to the linking portion 14d, the upper wall 14a will be less likely to bend and thus there is a risk that the retainer 14 may not function normally, but this risk can be avoided.

(4) The second locking portion 42 of the upper wall 14a is configured to move over the third protrusion 33 of the housing 13 due to the upper wall 14a bending in the upward direction Z1 when the retainer 14 moves between the temporary locking position and the full locking position. Thus, the retainer 14 is prevented from being easily, for example unintentionally, switched to the temporary locking position or the full locking position. That is, the second locking portion 42 functions in a manner similar to that of the first locking portion 41. Thus, the retainer 14 is further prevented from being easily, for example unintentionally, switched to the temporary locking position or the full locking position. In other words, the state in which the retainer 14 is located at the temporary locking position or the full locking position can be more reliably maintained.

(5) In the state in which the retainer 14 is located at the temporary locking position, the surface of the fourth protrusion 34 facing the second locking portion 42 is the first orthogonal surface 34a orthogonal to the attachment direction Y1, and the surface of the second locking portion 42 facing the fourth protrusion 34 is the second orthogonal surface 42a orthogonal to the attachment direction Y1. Thus, a component force that bends the upper wall 14a in the upward direction Z1 is unlikely to be generated. This inhibits a large force from being applied to the key protrusion 43a and the key recess 32a. Also, the engagement between the fourth protrusion 34 and the second locking portion 42 also prevents the retainer 14 from separating from the housing 13.

### Modification Examples

The above embodiment can be modified and implemented as follows. The above embodiment and the following modification examples may be combined and implemented to the extent that they do not contradict each other technically.
Although the separation preventing portion 43 is provided at an end portion of the upper wall 14a in the attachment forward direction Y1 in the above embodiment, the present invention is not limited to this, and the separation preventing portion 43 may be provided at a portion other than the end portions.
Although the retainer 14 has the linking portion 14d that links the upper wall 14a and the lower wall 14b together at the end portion in the insertion forward direction X1 of the terminals 12 in the above embodiment, the present invention is not limited to this, and a configuration may be adopted in which no linking portion 14d is provided.
Although the first locking portion 41, the second locking portion 42, and the separation preventing portion 43 are provided at the end portion of the upper wall 14a that is opposite to the linking portion 14d in the above embodiment, the present invention is not limited to this, and these portions may be provided at portions other than the end portions.
Although the connector 11 is configured to have the third protrusion 33 and the second locking portion 42 that function in the same manner as the first protrusion 31 and the first locking portion 41 in the above embodiment, the present invention is not limited to this, and a configuration may be adopted in which the connector 11 does not have the third protrusion 33 or the second locking portion 42.
Although the fourth protrusion 34 is configured to have the first orthogonal surface 34a orthogonal to the attachment direction Y1 and the second locking portion 42 is configured to have the second orthogonal surface 42a orthogonal to the attachment direction Y1 in the above embodiment, a configuration may be adopted in which the first orthogonal surface 34a and the second orthogonal surface 42a are not provided.
Although the configuration is adopted in the above embodiment in which the tubular portion 13a of the housing 13 has the guide groove 13d and the upper wall 14a has the guide rib 44, a configuration may be adopted in which the guide groove 13d and the guide rib 44 are not provided.
Although the guide rib 44 has the inclined portion 44a at its end portion in the attachment forward direction Y1, the inclined portion 44a protruding from the upper wall 14a with the amount of the protrusion decreasing toward the end portion in the above embodiment, the present invention is not limited to this, and a configuration may be adopted in which no inclined portion 44a is provided.
Although the guide rib 44 is provided continuously over the entire upper wall 14a in the attachment direction Y1 in the above embodiment, the present invention is not limited to this, and a configuration may be adopted in which a plurality of guide ribs 44 are provided apart from each other in the attachment direction Y1, for example.
Although the guide rib 44 is provided at a distance from the first locking portion 41 and the second locking portion 42 in the insertion direction X1 of the terminals 12 in the above embodiment, the present invention is not limited to this, and the guide rib 44 may be continuous with the first locking portion 41 and the second locking portion 42, for example.
Although the guide groove 13d is shaped to have the bottom portion 13e in the above embodiment, the present invention is not limited to this, and the guide groove 13d may be a through hole having no bottom portion 13e, for example.
Although the lower wall 14b has the base portion 14e that extends along the attachment direction Y1 and fits into the continuous hole 13c in the above embodiment, the present invention is not limited to this, and a configuration may be adopted in which the base portion 14e is not provided. That is, for example, the base portion 14e for preventing the retainer 14 from being displaced relative to the housing 13 to be inclined from the attachment direction Y1 may not be provided on the lower wall 14b side.
Although the guide rib 44 is provided such that the entire guide rib 44 is accommodated in the range where the base portion 14e is provided, in the insertion direction X1 of the terminals 12 in this embodiment, the present invention is not limited to this, and the guide rib 44 may be provided at a position where only a portion of the guide rib 44 overlaps with the range where the base portion 14e is provided. Also, for example, the guide rib 44 may be provided at a position where the guide rib 44 does not overlap with the base portion 14e in the insertion direction X1 of the terminals 12.
Although the connector 11 is configured to have three terminals 12 in the above embodiment, the present invention is not limited to this, and the configuration may be changed to a configuration in which two terminal 12 or four or more terminals 12 are provided, for example.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector comprising:
a terminal;
a housing into which the terminal is inserted; and
a retainer attached to the housing in an attachment direction intersecting an insertion direction of the terminal,
wherein the retainer has an upper wall and a lower wall that are parallel to each other and between which the housing is disposed, and a base end linking wall that links the upper wall and the lower wall together at an end portion in an attachment rearward direction, and is movable between a temporary locking position at which movement of the terminal in and out of the housing is allowed and a full locking position that is located in an attachment forward direction relative to the temporary locking position and at which movement of the terminal out of the housing is restricted,
the housing has a first protrusion and a second protrusion positioned in the attachment forward direction relative to the first protrusion,
the upper wall has a first locking portion positioned in the attachment rearward direction relative to the first protrusion at the temporary locking position and positioned between the first protrusion and the second protrusion at the full locking position, and a separation preventing portion positioned in the attachment forward direction relative to the second protrusion at the temporary locking position and at the full locking position,
the first locking portion is capable of moving over the first protrusion due to the upper wall bending upward when the retainer moves between the temporary locking position and the full locking position,
the second protrusion has a key recess that is recessed in the attachment rearward direction, and
the separation preventing portion has a key protrusion that fits into the key recess at the temporary locking position to prevent the upper wall from bending upward.

2. The connector according to claim 1,
wherein the separation preventing portion is provided at an end portion of the upper wall in the attachment forward direction.

3. The connector according to claim 1,
wherein the retainer has a linking portion that links the upper wall and the lower wall together at an end portion in an insertion forward direction of the terminal, and
the first locking portion and the separation preventing portion are provided at an end portion of the upper wall that is opposite to the linking portion.

4. The connector according to claim 1,
wherein the housing has a third protrusion positioned in the attachment rearward direction relative to the first protrusion,
the upper wall has a second locking portion positioned in the attachment rearward direction relative to the third protrusion at the temporary locking position and positioned between the first protrusion and the third protrusion at the full locking position, and
the second locking portion is capable of moving over the third protrusion due to the upper wall bending upward when the retainer moves between the temporary locking position and the full locking position.

5. The connector according to claim 4,
wherein the housing has a fourth protrusion positioned in the attachment rearward direction relative to the third protrusion,
the second locking portion is positioned between the third protrusion and the fourth protrusion in a state in which the retainer is located at the temporary locking position,
in the state in which the retainer is located at the temporary locking position, a surface of the fourth protrusion facing the second locking portion is a first orthogonal surface that is orthogonal to the attachment direction, and
in the state in which the retainer is located at the temporary locking position, a surface of the second locking portion facing the fourth protrusion is a second orthogonal surface that is orthogonal to the attachment direction.
